(19) United States
(12) Patent Application Publication
(10) Pub. No.: US 2008/0173181 A1
(43) Pub. Date: Jul. 24, 2008

(54) MACHINE WITH A COMPLETELY REMOVABLE BREWING CHAMBER

(75) Inventor: Armin Startz, Weidenstetten (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WMF WUERTTEMBERGISCHE METALLWARENFABRIK AG, Geislingen (DE)

(21) Appl. No.: 12/013,767

(22) Filed: Jan. 14, 2008

(30) Foreign Application Priority Data
Jan. 24, 2007 (EP) 07001475.8

(51) Int. Cl. A47J 31/00; A23L 1/00

(52) U.S. Cl. 99/279; 426/431

(57) ABSTRACT

Please substitute the following paragraph(s) for the abstract now appearing in the currently filed specification:

A machine and a method for the preparation of a hot drink with a housing, a water tank and a reclosable brewing chamber, which can be charged and emptied in the opened state. In order to improve handling, the brewing chamber can be completely removed from the housing for charging, emptying and cleaning.

### CROSS-REFERENCE TO RELATED APPLICATION

The present application claims the benefit of priority of European Patent Application No. EP 07001475.8, filed Jan. 24, 2007. The entire text of the priority application is incorporated herein by reference in its entirety.

### FIELD OF DISCLOSURE

The disclosure relates to a machine for the preparation of a hot drink such as coffee drinks, a machine system with a machine of this nature and a method of preparing a hot drink.

### BACKGROUND

Machines of this nature, in particular coffee machines, in which brewing water is passed over the coffee grounds under pressure, are already known from the state of the art.

The coffee machines have a brewing chamber, which is sealed against the environment during brewing. The brewing chamber is here generally realized in two parts with at least one part being arranged movable on the machine. In WO 2005/072572 a drawer, for example, is described which represents the lower part of the brewing chamber. The upper part of the brewing chamber is fastened to the machine. In EP 090471 A1 a further method of realizing a brewing chamber of this nature is described. Here, the upper part of the brewing chamber is supported for swiveling.

However, the coffee machines known from the state of the art have significant disadvantages. Due to the fact that at least one part of the brewing chamber is arranged on the machine, complicated sealing mechanisms are required which seal the system against the environment. The axial forces arising during brewing due to the increased internal pressure must be taken up by the sealing system.

The part connected to the machine is accessible only with difficulty and can therefore only be cleaned with difficulty or not at all. It must be dismantled for maintenance or cleaning.

Often special tools are required to replace the attached brewing chamber part. Thus, the customer cannot easily replace the brewing chamber.

Furthermore, the construction severely restricts the design freedom.

### SUMMARY OF DISCLOSURE

Against this background the object of the present disclosure is to provide an improved machine and a method of preparing a hot drink, which facilitates simplified and more practicable handling, enabling the machine to be cleaned easily and thoroughly.

Due to the fact that the brewing chamber is not fastened to the housing, but instead can be removed completely from the housing, all parts coming into contact with the coffee grounds can be cleaned very easily outside of the machine. In the removed state the brewing chamber can then be opened and filled with the medium to be brewed. The brewing chamber can then be closed again and the complete unit inserted into the machine housing. Then, brewing water can be passed into the brewing chamber tinder pressure, wherein the brewing chamber is sealed such that an increased pressure can build up in the brewing chamber and the prepared hot drink can thereafter flow out of the brewing chamber. Due to the fact that the brewing chamber can be filled and emptied as a complete unit outside of the housing, simplified and cleaner handling results.

According to a preferred embodiment, the brewing chamber is constructed in two parts. It preferably has an upper and a lower part. The upper part and the lower part are connected by a locking mechanism. The locking mechanism, for example thread cams or a bayonet lock, locks the brewing chamber and takes up the axial forces arising due to the over pressure during brewing.

In an advantageous way the housing has a drawer compartment into which the brewing chamber can be inserted. The insertion of the brewing chamber facilitates the simple replacement of the brewing chamber in the housing. In an advantageous way the dimensions of the drawer compartment can be formed such that the upper side of the upper part and the underside of the lower part contact the drawer compartment at least partially. A positive locking connection of this nature between the brewing chamber and the housing has the advantage that consequently the axial forces acting due to the over pressure in the brewing chamber can be taken up and thus pressure onto the brewing chamber can be effectively prevented.

It is also advantageous if the dimensions of the drawer compartment are formed such that the brewing chamber contacts the drawer compartment at the side so that the chamber halves are also fixed with respect to one another in the radial direction. Radial brewing forces are taken up directly by the chamber halves.

A joint gap between the upper part and the lower part of the brewing chamber is sealed by an internal seal, for example a sealing ring.

The brewing chamber has an opening section via which the brewing water is passed, wherein sealing between the brewing chamber and the housing is also provided in this region.

Through the above mentioned measures, ideal sealing of the brewing chamber is achieved in a simple manner without complicated sealing mechanisms. Furthermore, no sealing mechanisms which are subject to wear are required on the housing.

Advantageously, the brewing chamber has a coding, which indicates a certain type of brewing chamber and furthermore the machine has a sensor device which acquires the coding. Thus, the individual brewing chambers can be specially designed for the medium to be prepared, e.g. coffee grounds, coffee pads, coffee capsules, open tea, etc., and individually interchanged by the customer. When the sensor device acquires the coding, the machine can control the brewing process in dependence of the acquired coding, which corresponds to a certain type of pressure chamber. Thus, it is ensured that for a certain medium to be prepared a brewing process suitable for it is selected.

According to a preferred embodiment the machine has a region for inserting a container, e.g. a cup. In an advantageous way the drawer compartment is arranged in or above this region. Thus, the brewing chamber is particularly easily accessible externally. The construction and design of the machine can therefore be significantly simplified. The brewing chamber can be particularly easily grasped when it protrudes over an outer side of the housing, e.g. over the front.

### BRIEF DESCRIPTION OF THE DRAWINGS

The present disclosure is explained in more detail in the following with reference to the following figures:

FIG. 1 shows schematically a perspective illustration of a machine according to the present disclosure with an inserted brewing chamber.

FIG. 2 shows schematically in a perspective illustration the machine illustrated in FIG. 1 with the brewing chamber removed.

FIG. 3 shows the upper part and lower part of the brewing chamber in a perspective illustration.

FIG. 4 shows an exploded view of the main parts of the machine illustrated in FIGS. 1 and 2.

FIG. 5 shows a perspective illustration of the upper part of the brewing chamber according to the present disclosure.

FIG. 6 shows schematically a section through a brewing chamber according to the disclosure.

FIG. 7 illustrates an exploded view of a possible embodiment of a brewing chamber according to the present disclosure.

FIG. 8 shows a side view of the machine illustrated in FIG. 1.

### DETAILED DESCRIPTION OF THE DISCLOSURE

In the following the present disclosure is described in conjunction with a single-cup machine for the preparation of a hot drink. Particularly with a single-cup system, it is especially advantageous if the cleaning and filling of the brewing chamber with the medium to be brewed can be particularly easily undertaken. The present disclosure is however not restricted to a single-cup system of this nature.

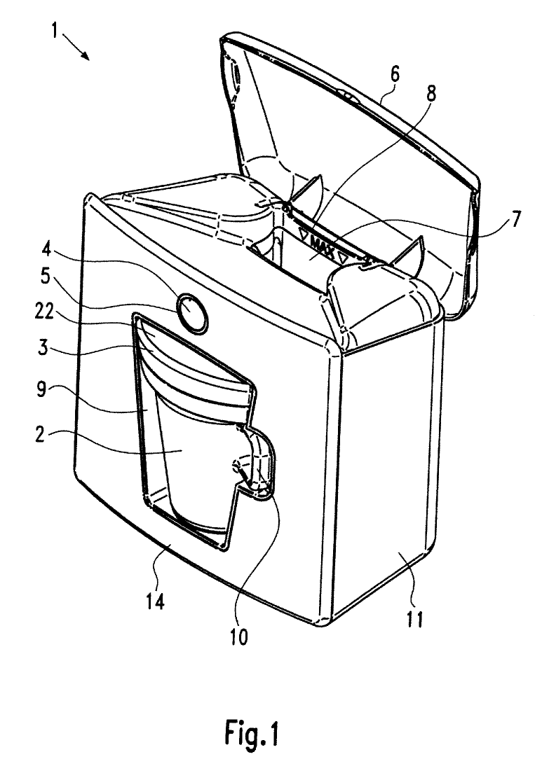

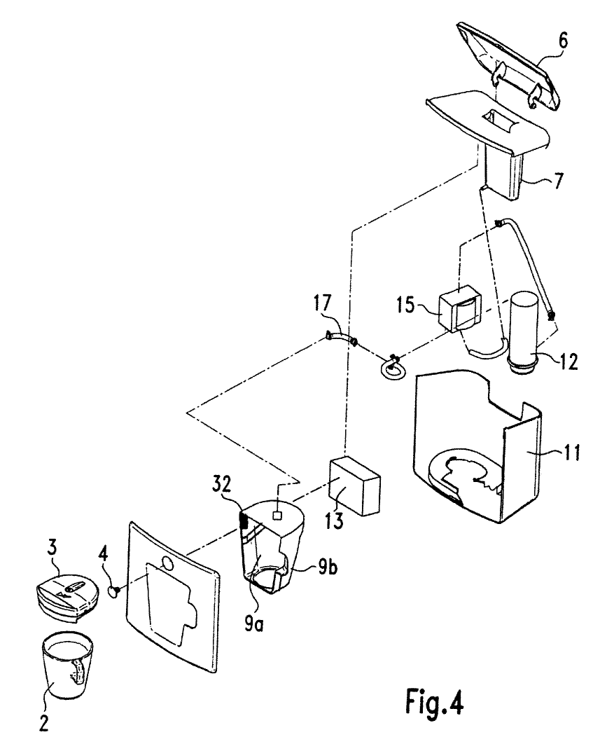

FIG. 1 shows in a perspective illustration a possible embodiment of a machine 1 for the preparation of a hot drink. FIG. 4 shows an exploded view of the most important components. A machine 1 of this nature can for example prepare coffee or tea, etc. The machine 1 has a housing 11, which on its upper side has a cover 6, with which the housing 11 can be opened and closed. In the housing 11 there is a water tank 7 with a filling-level mark 8, up to which water can be filled for the hot drink. The machine 1 is, as already mentioned, a single-cup machine. The size or the volume capacity of the water tank 7 is designed such that it can only accept the amount of water required for producing one cup 2 of a hot drink. The predetermined volume is here, for example, in a range of approximately 100 to 200 ml depending on the size of the cup. Due to the small water tank volume, the tank is empty at the end of the brewing. Thus, no contamination can occur due to keeping water in the tank for a long period.

Furthermore, the machine 1 has a heating system 12 which is illustrated in FIG. 4 and which heats the water from the water tank 7. Here, boiler systems or unit heaters can be employed. The heater system 12 is rated such that it is sufficient for heating an amount of water for only one cup of hot drink. The machine 1 therefore has only a brewing amount for which the size and power of the heating system 12 is rated. Therefore with the single-cup system according to the disclosure only the amount of energy is passed which is required for providing one cup of brewing water. Thus, in contrast to other appliances, the brewing water for one cup can be provided in a more energy efficient manner.

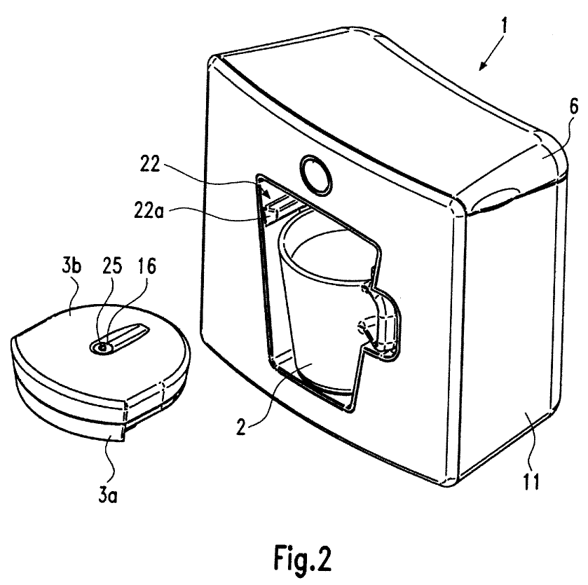

Furthermore, as can be seen from FIGS. 1 and 2, the machine has a region 9 for the accommodation of a cup 2 into which the hot drink is discharged.

The size of the chamber 9 is selected such that a cup 2 can be located there. The inserted brewing chamber 3 is located in the upper region of the chamber 9. With an inserted brewing chamber 3 a cavity is produced, the longitudinal section of which (parallel to the face side 14 of the housing 11) has a shape which matches, i.e. is complementary to, the shape of the cup 2 located in it. This means that the inner side of the chamber 9 is matched to the shape of the cup 2. A spacing should be provided between the cup 2 and the chamber 9 so that the cup can be easily inserted and removed. In order that also cups with handles can be used, the chamber 9 has at least on one side a region 9b which extends from a side wall of the main region 9a sidewards to accommodate for example a handle 10 of the cup 2. This embodiment facilitates a very space-saving arrangement of the region for the accommodation of the cup 2 so that overall space can be saved.

Furthermore, the machine 1 only has one button 4 for the complete operation. The button 4, which is formed here as a pushbutton, has an illuminated indicator 5, here in the form of an illuminated ring 5.

The button or the switch 4 is connected to the control unit 13 which in turn is connected to the heating system 12, pump 15 and to the illuminated indicator 5. The illuminated indicator 5 here indicates the main operating states of the machine.

When the button 4 is pressed, the machine switches on. The machine 1 is then controlled by the control unit 13 such that precisely the amount of water is brewed which is located in the tank. That is, the specific amount of energy is supplied to the heating system 12 which is required to produce brewing water for one cup 2 and all the water is pumped out of the tank. The specific amount of energy can be specified beforehand in dependence of the cup volume, i.e. it can be constant. However, it is also possible to determine the end of the heating process via appropriate measurements (e.g. temperature or pressure, etc.). The control unit can also provide an appropriate signal to the pump so that the complete amount of water in the tank is pumped off. At the same time the control unit 13 also switches the illuminated indicator on which lights up and thus indicates that the machine is in operation.

Once an adequate amount of energy has been passed, the energy feed is terminated. The heated water can be pressed into the brewing chamber 3 under pressure through an appropriate pipe via the sealing device 16, wherein an increased pressure is built up in the brewing chamber 3. A specific amount of product can then be discharged into the cup at the lower end of the brewing chamber 3.

After termination of the energy feed and the brewing process, the control unit 13 can immediately switch off the illuminated indicator or after a certain time period. The machine then switches off automatically. The machine remains switched off as long as the button 4 is not pressed.

Advantageously, a single-cup system for preparing one cup of a hot drink here has the machine 1 according to the disclosure as well as at least one suitable standard cup 2, the volume of which is known, wherein the size and shape of the chamber, as previously described, match the cup 2 and also the heating power of the heating system 12 and the charging volume of the tank 7 are adapted to the cup volume.

According to the present disclosure, the brewing chamber 3 is not fastened to the housing 11, but can instead be completely removed. FIG. 1 illustrates the machine 1 with the brewing chamber 3 completely inserted. FIG. 2 illustrates the machine 1 with the brewing chamber 3 removed. Fully or completely removable indicates here that both parts, that is the upper part 3b as well as the lower part 3a of the brewing chamber can be simultaneously removed as one unit from the machine 1. Coffee powder, coffee pads, capsules or tea powder, etc. can be charged into the brewing chamber 3.

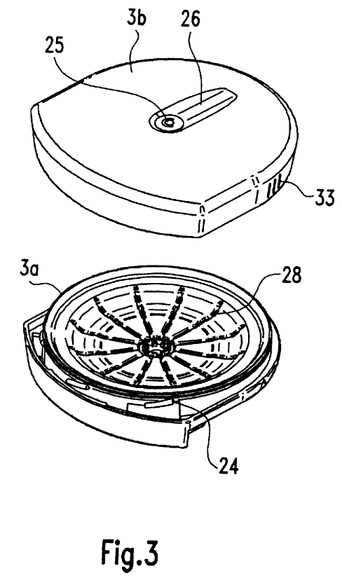

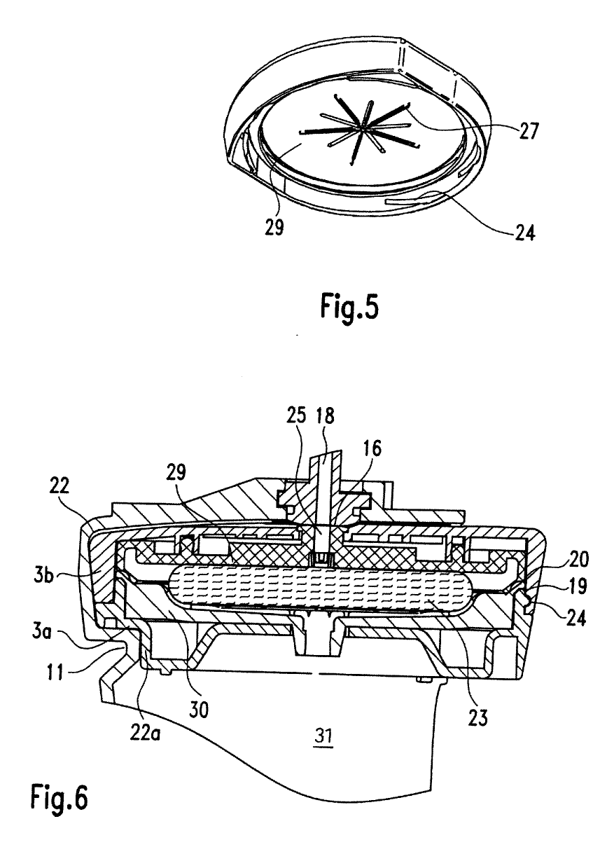

As can be seen from FIGS. 3, 5 and 6, the brewing chamber 3 is formed in two parts. It comprises the upper part 3b and a lower part 3a, which can be connected by a locking mechanism 24. A locking mechanism 24 of this nature can for example be realized by thread cams 24 (refer to FIG. 5), or also however by a screw lock or a bayonet lock, etc. Locking mechanisms of this nature are extraordinarily low on wear. The two parts of the brewing chamber 3a, b have, as can be seen from FIG. 6, a joint gap 19. This joint gap is sealed by an internal seal 20, preferably an appropriate sealing ring. Due to the increased pressure in the brewing chamber 3, the sealing ring is then pressed onto the joint gap 19, with the result that a very good seal can be realized.

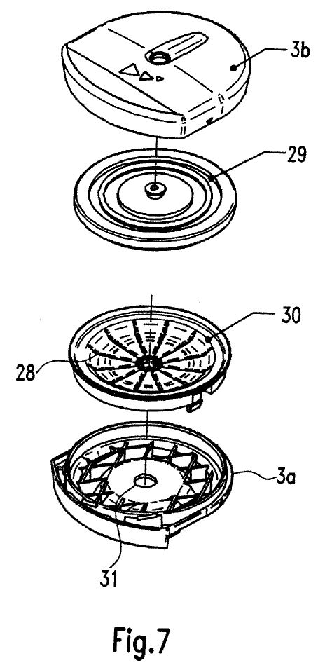

As can be seen in particular from FIG. 7, in this embodiment the brewing chamber 3b also has a lower insert 30 and an upper insert 29. The lower insert 30 is inserted into the lower part 3a and has radially extending webs 28 which lead to an outlet 31 of the brewing chamber and which favorably affect the course of the brewed medium to the dispenser 31. Also the insert 29, which is fastened to the upper part 3b, has, as can be seen in FIG. 5, radially extending webs or channels 27, which extend outwards from a section 25, from which brewing water is fed into the brewing chamber 3. Here, the upper insert acts as a sealing system. As can be seen from FIG. 6, the lower insert 30 extends into the lower opening of the lower part 3a and forms the discharge opening. Here, the insert on the lower part 3a is fixed using snap-on hooks.

The housing 11 has a drawer compartment 22 (for example with a drawer rail 22a) into which the brewing chamber 3 is inserted. The drawer compartment 22 is designed such that the brewing chamber 3 takes up an accurate position in the housing 11 and is aligned exactly to the feed 18 (refer to FIGS. 4 and 6) through which the brewing water is passed. Thus, brewing water, which has been pumped out of the water tank 7 with the aid of a pump 15 and which has been heated by the heating system 12, can be introduced into the brewing chamber 3 under high pressure via the brewing water feed 18. Here also a seal 16 (refer to FIG. 6) is provided which seals the brewing chamber to the housing 11.

The arising brewing pressure also causes axial forces acting on the parts of the brewing chamber 3a, b. Pressure on the brewing chamber can be prevented by

a) positively locked joining of the parts of the brewing chamber 3a, b with the housing 11. Here, the dimensions of the drawer compartment 22 and the brewing chamber 3b are formed such that the surface of the upper part 3b and the underside of the lower part 3a contact the drawer compartment 22 at least partially. Thus, the axially acting force can be taken up by the housing 11 with the result that the brewing chamber is not subject to pressure,

b) the parts of the brewing chamber 3a, b are, as previously described, firmly closed outside of the machine by the locking mechanism, such as for example the thread cams 24 or a bayonet lock, etc. This locking system then takes up the arising axial forces.

A combination of the measures a) and b) is particularly effective.

Advantageously, the drawer compartment 22 is dimensioned such that the brewing chamber 3 contacts the drawer compartment at the side. Thus the parts of the brewing chamber 3a, b are also fixed with one another in the radial direction after insertion into the drawer compartment 22. Radial brewing forces are then taken up directly by the parts of the brewing chamber 3a, b.

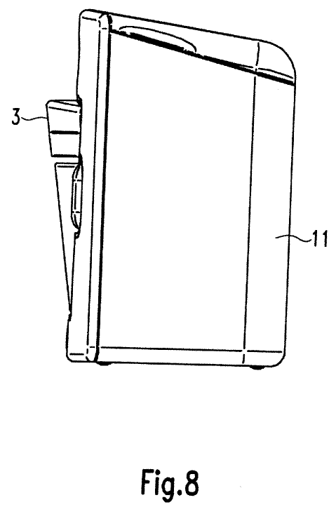

In an advantageous way, as can be seen from FIG. 8, the brewing chamber protrudes over the front 14 of the housing or over the drawer chamber 22 so that it can be easily gasped.

As can be seen from FIG. 3, the upper side of the upper part 3b has the opening of the previously mentioned pipe section 25, through which the brewing water is fed. Furthermore, the surface has an indentation 26, which enables the brewing chamber to be inserted into the drawer compartment 22 and to be connected to the feed 18 of the machine at the correct point.

According to a preferred embodiment a machine system has various types of brewing chamber. The different brewing chambers 3 can be specially designed for the medium 23 to be prepared, e.g. coffee grounds, coffee pads, coffee capsules, open teas, etc., and individually interchanged by the customer.

It is advantageous if then the various brewing chambers have different coding, which, as shown for example in FIG. 3, can be arranged at the side of the brewing chamber 3. The machine 1 can have a sensor device 32 (refer to FIG. 4), which can detect the coding (e.g. in the form of a reed switch). An appropriate signal can then be passed to the control device 13. The controller 13 then controls the brewing process in dependence of the detected brewing chamber so that a brewing process suitable to the appropriate medium is carried out.

According to the present disclosure, in the operational method for preparing a hot drink, the brewing chamber 3, which is removed from the housing, is opened and filled with the medium 23 to be brewed. The brewing chamber is then closed in that the upper part and the lower part of the brewing chamber 3 are joined together and preferably locked by a locking mechanism 24. The brewing chamber 3 is then inserted into the drawer compartment 22 of the machine housing 11 as a complete unit so that, as can be seen in FIG. 6, the pipe section 25 in the brewing chamber comes into contact with the feed 18 in the machine. When an appropriate button 4 has been pressed, brewing water is passed under pressure into the brewing chamber 3 (as has been previously described in conjunction with the single-cup system). The finished hot drink then passes via the discharge opening 31 out of the brewing chamber 3 into a container, preferably into the cup 2.

For emptying the medium the brewing chamber can be withdrawn from the drawer compartment 22 as a complete unit with just one grasp of the hand. The brewing chamber 3 can then be opened outside of the housing, wherein all parts coming into contact with coffee can be easily cleaned by the customer.

The present disclosure has the advantage that on the appliance, i.e. on the machine housing 11, no sealing mechanism is required which is subject to wear, as is the case with the state of the art. All parts coming into contact with the medium to be extracted can be very easily cleaned outside of the machine. All parts coming into contact with the medium to be extracted can furthermore be easily interchanged by the customer by replacing the brewing chamber. Furthermore, there is much more freedom in design.

1. Machine (1) for the preparation of a hot drink, comprising a housing (11), a water tank (7) and a reclosable and refillable brewing chamber (3), and wherein the brewing chamber (3) can be completely removed from the housing for charging, emptying and cleaning.

2. Machine (1) according to claim 1, wherein the brewing chamber (3) comprises an upper part (3b) and a lower part (3a).

3. Machine according to claim 2, wherein the upper part (3b) and the lower part (3a) are joined by a locking mechanism (24).

4. Machine according to claim 1, wherein the housing (11) has a drawer compartment (22), into which the brewing chamber (3) can be inserted as a complete unit.

5. Machine according to claim 4, wherein the dimensions of the drawer compartment (22) are formed such that the upper side of the upper part (3b) and the underside of the lower part (3a) contact the drawer compartment (22) at least partially.

6. Machine according to claim 4, wherein the dimensions of the drawer compartment (22) are formed such that the brewing chamber (3) contacts the drawer compartment (22) at the side.

7. Machine according to claim 2, wherein a joint gap (19) between the upper part (3b) and the lower part (3a) is sealed by an internal seal (20).

8. Machine according to claim 1 the brewing chamber (3) has a section through which brewing water can be passed, wherein in this region a seal (16) is provided between the brewing chamber (3) and the housing (11).

9. Machine according to claim 1, wherein the brewing chamber (3) has a coding (33), which indicates a certain type of brewing chamber, and a sensor device (32) is provided which acquires the coding.

10. Machine according to claim 9, wherein the machine (1) has a controller (13), which controls the brewing process in dependence of the acquired coding (33).

11. Machine according to claim 1, wherein the machine (1) has a region (9) for inserting a container (2).

12. Machine according to claim 11, wherein the drawer compartment is arranged one of in or above the region (9) for inserting a container.

13. Machine according to claim 1, wherein the brewing chamber (3) protrudes over an outer side of the housing (11).

14. Machine according to claim 1, and several different brewing chambers of a different type, each different brewing chamber being designed for a medium to be processed.

15. Machine according to claim 14, wherein the different types of brewing chambers each have an appropriate coding (33).

16. Method of preparing a hot drink with a machine (1) according to claim 1, and opening the brewing chamber (3), which is removed as a complete unit from the housing (11) and charging the brewing chamber (3) with the medium (23) to be brewed,
closing and inserting the brewing chamber (3) into the machine housing (11) as a complete unit,
passing brewing water into the brewing chamber (3) under pressure, and
passing out the prepared hot drink of the brewing chamber (3).

17. Method according to claim 16, and removing the brewing chamber (3) from the housing (11) as a complete unit and opening the brewing chamber (3) for emptying the medium.
